(19) United States
(12) Patent Application Publication
(10) Pub. No.: US 2007/0068004 A1
(43) Pub. Date: Mar. 29, 2007

(54) Scissors with a drain, particularly for collecting lubricant

(76) Inventors: Uwe Schlichting, Wuppertal (DE); Schultz Erhard, Solingen (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/506,485

(22) Filed: Aug. 18, 2006

(30) Foreign Application Priority Data
Aug. 18, 2005 (DE) 102005039530.9

(51) Int. Cl. B26B 13/00

(52) U.S. Cl. 30/194

(57) ABSTRACT

In order to provide lubricant to scissors (1), which is available to the scissors (1) over a long period of time as a deposit in the area of the hinge (2), we recommend that at least one arm (3, 4) be provided with a drain (11), which empties into the slot (9), that the drain (11) border the moving face (10), and that the drain (11) be surrounded by a wall (12).

The drain (11) can be milled into the arm (3, 4) to thus be filled with lubricant (FIG. 2).

The invention is related to scissors, especially scissors used by barbers and hairdressers with two arms that rotate around a hinge, one cutting edge on a blade of an arm, as well as a gripping element, especially one gripping ring per arm. The hinge consists of a pin protruding through a slot in the arm to connect the arms with each other by means of the hinge. The arms lie one on top of the other with one moving face each in the area of the hinge.

Scissors of this type have been known for a very long time. They have the disadvantage that they must be provided with lubricant for the hinge from time to time to be able to use them with absolute ease of motion over a long period of time. This oiling must be provided by a salon employee or a technician.

The object was to design scissors in such a way that they can be provided with lubricant for an extremely long time period.

The object is achieved by providing a drain on at least one arm designed so that the drain empties into the slot, that the drain borders on the moving face, and that the drain is surrounded by a wall. This makes it possible to put lubricant into the drain, which this ensures that the hinge is always provided with lubricant to reduce friction over the course of time. The drain can be milled into the arm in question, which is relatively cost-effective.

The invention is described below with the aid of diagrams illustrating an embodiment. The following is shown:

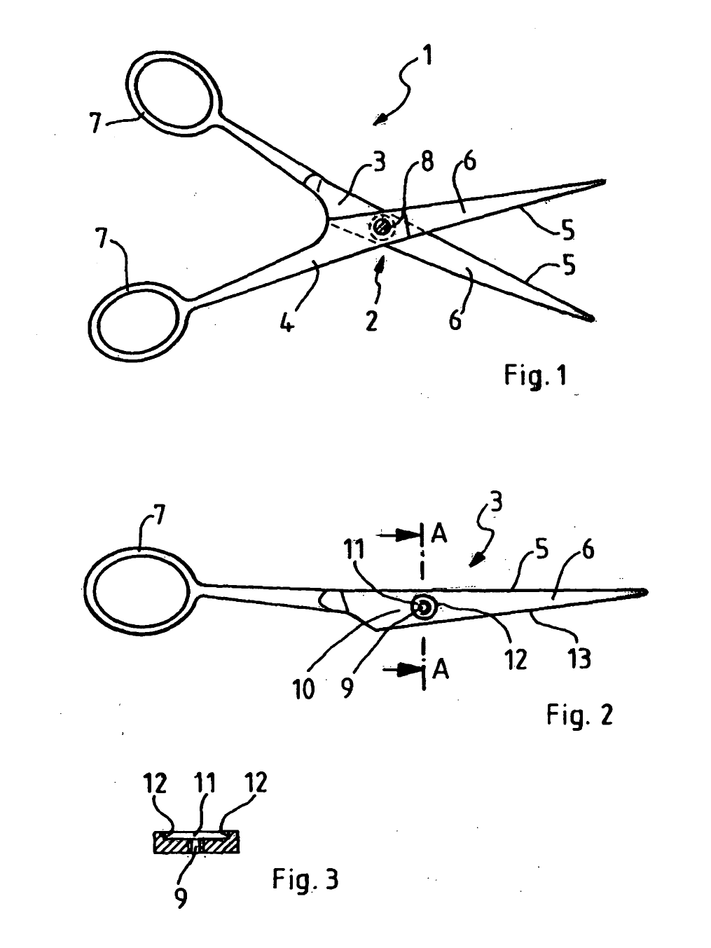

FIG. 1 A pair of scissors, opened

FIG. 2 An arm of the scissors of FIG. 1, wherein a drain surrounds a slot drilled in the arm

FIG. 3 The arm of FIG. 2 in a cross section along A-A.

A pair of scissors 1 for use by barbers and hairdressers has two arms 3, 4 able to rotate on a hinge 2. Each blade 6 of an arm 3, 4 has a cutting edge 5 as well as a gripping element designed in the form of a gripping ring 7. The hinge 2 is formed by a pin 8 protruding through a slot 9 in the arm 3, 4 joining the arms 3, 4 together by means of the hinge. The arms 3, 4 lie one on top of the other, each with a moving face 10 in the area of the hinge 2. One arm 3 has a drain 11 that opens into the slot 9. The drain 11 borders on the moving face 10. The drain 11 is completely enclosed by a wall 12.

Lubricant, e.g., some type of grease, can be placed in the drain 11 to continuously grease the area of the hinge 2. In this process, the grease penetrates into the area between the pin 8 and the drain 4, which rotates around the pin 8.
1 Scissors
2 Joint
3,4 Arm
5 Cutting edge
6 Blade
7 Gripping ring
8 Pin
9 Slot
10 Moving face
11 Drain
12 Wall
13 Back

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Scissors comprising two arms able to rotate around a hinge with a cutting edge on the blade of each arm as well as a gripping element on each arm, wherein the hinge is formed by a pin protruding through a slot in each arm to join the arms together by means of the hinge, wherein the arms lie one on top of the other in the area of the hinge, each arm having a moving face, and wherein at least one of the arms comprises a drain which opens into a slot, and wherein the drain borders on the moving face and the drain is surrounded by a wall.

2. Scissors according to claim 1, wherein the drain is filled with a lubricant.

3. Scissors according to claim 1, wherein the drain is milled.

4. Scissors according to claim 1, wherein said gripping element is a gripping ring.
